(19) United States
(12) Patent Application Publication
(10) Pub. No.: US 2013/0080028 A1
(43) Pub. Date: Mar. 28, 2013

(54) METHOD FOR OPERATING AN INTERNAL COMBUSTION ENGINE

(71) Applicant: GM GLOBAL TECHNOLOGY OPERATIONS LLC, Detroit, MI (US)

(72) Inventors: Morena BRUNO, Chivasso (Torino) (IT); Alessia TUNINETTI, Carmagnola (IT)

(73) Assignee: GM GLOBAL TECHNOLOGY OPERATIONS LLC, Detroit, MI (US)

(21) Appl. No.: 13/623,952

(22) Filed: Sep. 21, 2012

(30) Foreign Application Priority Data
Sep. 26, 2011 (GB) 1116599.0

(51) Int. Cl. F01N 11/00; F02D 41/26

(52) U.S. Cl. 701/102; 60/274

(57) ABSTRACT

An exemplary embodiment of the present disclosure provides a method for operating an internal combustion engine comprising: monitoring a value of a temperature parameter of a diesel particulate filter of the internal combustion engine; monitoring a value of an operating parameter of the internal combustion engine indicative of an engine load; using the monitored value of the engine load parameter to determine a threshold value of the diesel particulate filter temperature parameter; testing whether the monitored value of the diesel particulate filter temperature parameter exceeds the determined threshold value thereof; and diagnosing that the diesel particulate filter is overheated if the test returns positive.

### CROSS-REFERENCE TO RELATED APPLICATION

This application claims priority to British Patent Application No. 1116599.0, filed Sep. 26, 2011, which is incorporated herein by reference in its entirety.

### TECHNICAL FIELD

The technical field generally relates to a method for operating an internal combustion engine, typically an internal combustion engine of a motor vehicle.

### BACKGROUND

It is known that the exhaust gas produced by the fuel combustion within the cylinders of an internal combustion engine is discharged into the environment through an exhaust system, which generally comprises an exhaust manifold in communication with the engine cylinders, an exhaust pipe coming off the exhaust manifold, and one or more aftertreatment devices located in the exhaust pipe for trapping and/or changing the composition of the pollutant contained in the exhaust gas.

Among these aftertreatment devices, a Diesel engine generally comprises a Diesel Oxidation Catalyst (DOC) for degrading the residual hydrocarbons and carbon monoxides contained in the exhaust gas into carbon dioxides and water, and a Diesel Particulate Filter (DPF), which is located in the exhaust pipe downstream of the DOC, for trapping and thus removing diesel particulate matter (soot) from the exhaust gas.

A side effect of this aftertreatment device is that the DPF is heated by the exhaust gas flowing therein, so that it may overheat, if the temperature of the exhaust gas becomes excessive. This may damage the DPF.

In view of the above, it is desirable to reliably evaluate whether the DPF is overheated, in order to prevent any DPF damage and malfunction. It is also desirable to achieve this goal with a simple, rational and rather inexpensive solution. In addition, other objects, desirable features and characteristics will become apparent from the subsequent summary and detailed description, and the appended claims, taken in conjunction with the accompanying drawings and this background.

### SUMMARY

In one of various exemplary embodiments, provided is a method for operating an internal combustion engine comprising:
monitoring a value of a temperature parameter of a diesel particulate filter (DPF) of the internal combustion engine, typically a value of the exhaust gas temperature at the DPF inlet,
monitoring a value of one or more operating parameter(s) of the internal combustion engine indicative of an engine load, typically a value of an engine torque and/or a value of an engine speed,
using the monitored value of the engine load parameter(s) to determine a threshold value of the DPF temperature parameter,
testing whether the monitored value of the DPF temperature parameter exceeds the determined threshold value thereof, and
diagnosing that the diesel particulate filter is overheated if the test returns positive.

In other words, the present solution provides to diagnose a DPF overheating by comparing a current value of the DPF temperature parameter, which can be monitored by means of a dedicated sensor, with a dynamic threshold value thereof, which depends on the current value of the engine load parameter(s).

In this way, the present solution has the advantage that the diagnosis of the DPF overheating is reliable over a wide range of values of the engine load parameter(s).

Another advantage of the present solution is that, due to the simplicity of the algorithm and the few parameters involved, the diagnosis of the DPF overheating requires a small computational effort, which can be provided by a conventional engine control unit (ECU).

Still another advantage is that the diagnosis of the DPF overheating does not imply any additional sensor, because the engine load parameter(s) and the DPF temperature parameter are already monitored and used in many other control strategies of the internal combustion engine.

According to one of various aspects of the present disclosure, the monitored value of the engine load parameter(s) is (are) filtered before being used to determine the threshold value of the DPF temperature parameter.

This aspect is advantageous because the engine load parameters generally vary very fast, whereas the thermodynamic behavior of the DPF takes more time to change in response of a variation of the engine load parameters. As a consequence, the threshold value of the DPF temperature parameter, which is determined on the basis of the actual value of the engine load parameter(s), could vary too rapidly and become instable, thereby causing the diagnosis to fail, namely to return a false DPF overheating or to return a true DPF overheating but too late. The filtering stage of the monitored value of the engine operating parameter(s), which can be performed for example by means of a low pass filter, has the advantage of overcoming, or at least of positively reducing, the above mentioned drawback.

According to another of various aspects of the present disclosure, the threshold value of the DPF temperature parameter is determined by means of a calibrated model or map that receives as input the monitored value of the engine load parameter(s) and returns as output the threshold value.

This solution has the advantage that the model or map can be calibrated by means of an empirical activity, and then stored in a memory system associated to the ECU, so that the latter can carry out the diagnosis of the DPF overheating very rapidly and with a minimum of computational effort.

According to still another one of various aspects of the present disclosure, the engine operating method can comprise:
using the monitored value of the DPF temperature parameter to calculate a value of a gradient of the DPF temperature parameter,
performing the test only if the calculated value of the gradient of the DPF temperature parameter is positive.

This solution is advantageous because, in general, the DPF temperature parameter decreases very slowly. For example, the DPF temperature parameter decreases much more slowly than the engine load parameter(s) used to determine its dynamic threshold value. As a consequence, while the DPF temperature parameter is decreasing, it may happen that the dynamic threshold value decreases too quickly compared to the actual value of DPF temperature parameter, causing the diagnostic strategy to detect a false DPF overheating. By performing the test generally only if the gradient value of the DPF temperature parameter is positive (namely only if the DPF temperature parameter value is actually increasing), the above mentioned drawback is advantageously overcame.

An auxiliary aspect of this solution provides that the monitored value of the DPF temperature parameter is filtered before being used to calculate the gradient value thereof.

This filtering stage of the monitored value of the DPF temperature parameter, which can be performed for example by means of a low pass filter, has the advantage of improving the robustness of the gradient calculation, in order to better recognize whether the DPF temperature parameter is actually increasing or not.

According to one of various aspects of the present disclosure, the engine operating method can comprise:
activating a recovery strategy suitable to stop the increase of the DPF temperature, if the overheating of the DPF is diagnosed.

By way of example, the recovery strategy may provide for reducing the quantity of fuel and/or air which is supplied into the internal combustion engine.

In this way, it is advantageously possible to stop and control the temperature increase of the DPF, thereby preventing damages of the DPF itself as well as of other engine components.

The methods according to the various teachings of the present disclosure can be carried out with the help of a computer program comprising a program-code for carrying out the method described above, and in the form of a computer program product comprising the computer program.

The computer program product can be embodied as an internal combustion engine comprising a diesel particulate filter, an engine control unit (ECU), a memory system associated to the engine control unit, and the computer program stored in the memory system, so that, when the ECU executes the computer program, the method described above is carried out.

The method can be also embodied as an electromagnetic signal, said signal being modulated to carry a sequence of data bits which represent a computer program to carry out the method.

Another exemplary embodiment of the present disclosure provides an apparatus for operating an internal combustion engine equipped with a diesel particulate filter, comprising:
means for monitoring a value of a temperature parameter of the DPF,
means for monitoring a value of one or more operating parameter(s) of the internal combustion engine indicative of an engine load,
means for using the monitored value of the engine load parameter(s) to determine a threshold value of the DPF temperature parameter,
means for testing whether the monitored value of the DPF temperature parameter exceeds the determined threshold value thereof, and
means for diagnosing that the DPF is overheated if the test returns positive.

This exemplary embodiment of the present disclosure has the same advantage of the method disclosed above, namely that of providing a reliable strategy to diagnose a DPF overheating, which involves a low computational effort and which can be performed by a conventional engine control system.

Still another exemplary embodiment of the present disclosure provides an automotive system comprising:
an internal combustion engine equipped with a diesel particulate filter, a first sensor for evaluating a temperature parameter of the diesel particulate filter, one or more second sensor(s) for evaluating one or more operating parameter(s) of the internal combustion engine indicative of an engine load, and an electronic control unit in communication with the first and the second sensor, wherein the electronic control unit is configured to:
   monitor with the first sensor a value of the DPF temperature parameter,
   monitor with the second sensor(s) a value of the engine operating parameter(s),
   use the monitored value of the engine operating parameter(s) to determine a threshold value of the DPF temperature parameter,
   test whether the monitored value of the DPF temperature parameter exceeds the determined threshold value thereof,
   diagnose that the DPF is overheated if the test returns positive.

Also this exemplary embodiment of the present disclosure has the same advantage of the method disclosed above, namely that of providing a reliable strategy to diagnose a DPF overheating, which involves a low computational effort and which can be performed by a conventional engine control system.

A person skilled in the art can gather other characteristics and advantages of the disclosure from the following description of exemplary embodiments that refers to the attached drawings, wherein the described exemplary embodiments should not be interpreted in a restrictive sense.

### BRIEF DESCRIPTION OF THE DRAWINGS

The various embodiments will hereinafter be described in conjunction with the following drawing figures, wherein like numerals denote like elements, and wherein:

FIG. 1 shows an exemplary automotive system;

FIG. 2 is a section of an internal combustion engine belonging to the automotive system of FIG. 1; and

FIG. 3 is a flowchart of a method for operating the internal combustion engine belonging to the automotive system of FIG. 1.

### DETAILED DESCRIPTION

The following detailed description is merely exemplary in nature and is not intended to limit the present disclosure or the application and uses of the present disclosure. Furthermore, there is no intention to be bound by any theory presented in the preceding background or the following detailed description.

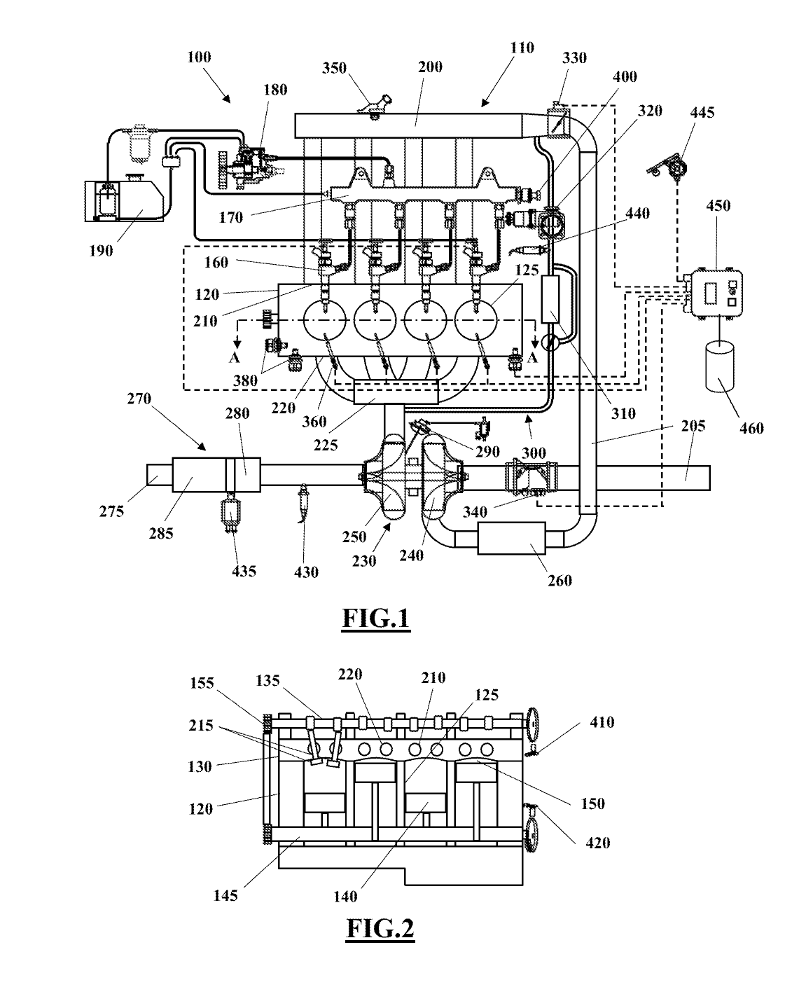

Some exemplary embodiments may include an automotive system 100, as shown in FIGS. 1 and 2, that includes an internal combustion engine (ICE) 110, particularly an ICE 110 of a motor vehicle, having an engine block 120 defining at least one cylinder 125 having a piston 140 coupled to rotate a crankshaft 145. A cylinder head 130 cooperates with the piston 140 to define a combustion chamber 150. A fuel and air mixture (not shown) is disposed in the combustion chamber 150 and ignited, resulting in hot expanding exhaust gasses causing reciprocal movement of the piston 140. The fuel is provided by at least one fuel injector 160 and the air through at least one intake port 210. The fuel is provided at high pressure to the fuel injector 160 from a fuel rail 170 in fluid communication with a high pressure fuel pump 180 that increases the pressure of the fuel received from a fuel source 190. Each of the cylinders 125 has at least two valves 215, actuated by a camshaft 135 rotating in time with the crankshaft 145. The valves 215 selectively allow air into the combustion chamber 150 from the port 210 and alternately allow exhaust gases to exit through at least one exhaust port 220. In some examples, a cam phaser 155 may selectively vary the timing between the camshaft 135 and the crankshaft 145.

The air may be distributed to the air intake port(s) 210 through an intake manifold 200. An air intake pipe 205 may provide air from the ambient environment to the intake manifold 200. In other exemplary embodiments, a throttle body 330 may be provided to regulate the flow of air into the manifold 200. In still other exemplary embodiments, a forced air system such as a turbocharger 230, having a compressor 240 rotationally coupled to a turbine 250, may be provided. Rotation of the compressor 240 increases the pressure and temperature of the air in the intake pipe 205 and manifold 200. An intercooler 260 disposed in the intake pipe 205 may reduce the temperature of the air. The turbine 250 rotates by receiving exhaust gases from an exhaust manifold 225 that directs exhaust gases from the exhaust ports 220 and through a series of vanes prior to expansion through the turbine 250. This example shows a variable geometry turbine (VGT) with a VGT actuator 290 arranged to move the vanes to alter the flow of the exhaust gases through the turbine 250. In other exemplary embodiments, the turbocharger 230 may be fixed geometry and/or include a waste gate.

The exhaust gases exit the turbine 250 and are directed into an exhaust system 270. The exhaust system 270 may include an exhaust pipe 275 having one or more exhaust aftertreatment devices. The aftertreatment devices may be any device configured to change the composition of the exhaust gases. Some examples of aftertreatment devices include, but are not limited to, catalytic converters (two and three way), oxidation catalysts, lean NOx traps, hydrocarbon adsorbers, selective catalytic reduction (SCR) systems, and particulate filters. In the present example, the aftertreatment devices can comprise a Diesel Oxidation Catalyst (DOC) 280 for degrading the residual hydrocarbons and carbon monoxides contained in the exhaust gas into carbon dioxides and water, and a Diesel Particulate Filter (DPF) 285, located downstream of the DOC 280, for trapping diesel particulate matter (soot) from the exhaust gas. The DOC 280 and the DPF 285 of the present example are closed coupled and accommodated inside a common external housing, however they can be also mutually separated and provided with dedicated housing.

Other exemplary embodiments may include an exhaust gas recirculation (EGR) system 300 coupled between the exhaust manifold 225 and the intake manifold 200. The EGR system 300 may include an EGR cooler 310 to reduce the temperature of the exhaust gases in the EGR system 300. An EGR valve 320 regulates a flow of exhaust gases in the EGR system 300.

The automotive system 100 may further include an electronic control unit (ECU) 450 in communication with one or more sensors and/or devices associated with the ICE 110. The ECU 450 may receive input signals from various sensors configured to generate the signals in proportion to various physical parameters associated with the ICE 110. The sensors include, but are not limited to, a mass airflow and temperature sensor 340, a manifold pressure and temperature sensor 350, a combustion pressure sensor 360, coolant and oil temperature and level sensors 380, a fuel rail pressure sensor 400, a camshaft position sensor 410, a crankshaft position sensor 420, lambda sensors 430, an EGR temperature sensor 440, and an accelerator pedal position sensor 445. In the present example, the sensors further include a pressure and temperature sensors 435 for sensing the pressure and the temperature of the exhaust gas at the inlet of the DPF 285, namely between upstream the DPF 285 and downstream the DOC 280. Furthermore, the ECU 450 may generate output signals to various control devices that are arranged to control the operation of the ICE 110, including, but not limited to, the fuel injectors 160, the throttle body 330, the EGR Valve 320, the VGT actuator 290, and the cam phaser 155. Note, dashed lines are used to indicate communication between the ECU 450 and the various sensors and devices, but some are omitted for clarity.

Turning now to the ECU 450, this apparatus may include a digital central processing unit (CPU) in communication with a memory system 460 and an interface bus. The memory system 460 may include various storage types including optical storage, magnetic storage, solid state storage, and other non-volatile memory. The interface bus may be configured to send, receive, and modulate analog and/or digital signals to/from the various sensors and control devices. The CPU is configured to execute instructions stored as a program in the memory system 460, and send and receive signals to/from the interface bus. The program may embody the methods disclosed herein, allowing the CPU to carryout out the methods and control the ICE 110.

For example, the ECU 450 is configured to control the fuel injection inside the combustion chamber 150, by operating each fuel injector 160 to perform several fuel injections per engine cycle according to a controllable fuel injection pattern.

The ECU 450 is also configured to diagnose whether the DPF 285 overheats, namely whether the temperature of the DPF 285 is so high to cause damages or malfunctions of the DPF 285 itself and/or of other engine components.

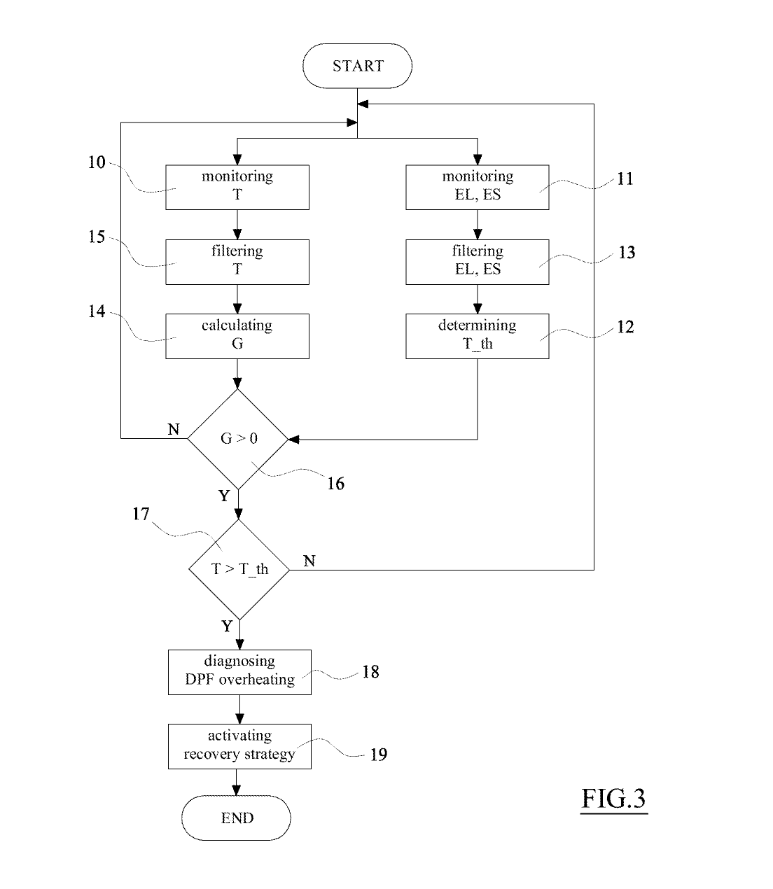

This diagnosis may be operated by the ECU 450 by means of the routine shown in the flowchart of FIG. 3.

The routine firstly provides for the ECU 450 to monitor (block 10) the current value T of the exhausts gas temperature at the inlet of the DPF 285, namely in the exhaust pipe 275 upstream of the DPF 285 and downstream of the DOC 280.

The current value T of the exhaust gas temperature can be measured by means of the temperature sensor 435.

Contemporaneously, the routine provides for the ECU 450 to monitor (block 11) the current value of one or more operating parameter(s) of the ICE 110, which are related with the engine load and which affect the thermodynamic behavior of the DPF 285, for example the engine torque and/or the engine speed.

In this particular example, the routine provides for monitoring both the current value ES of the engine speed and the current value ET of the engine torque.

The current value ES of the engine speed can be measured by the ECU 450 with the aid of the crankshaft position sensor 420, whereas the current value ET of the engine torque can be determined by the ECU 450 on the basis of the accelerator pedal position measured by the sensor 445 and other engine operating parameters. In this example, where the ICE 110 is already equipped with in-cylinder pressure sensors 360, the current value ET of the engine torque could also be measured by the ECU 450 with the aid of these in-cylinder pressure sensors 360.

The current value of the engine load parameter(s) are then applied as inputs to a calculation module 12, which provides as output a correlated threshold value T_th of the exhaust gas temperature at the DPF inlet.

The calculation module 12 uses a simplified model of the thermodynamic behavior of the inlet DPF temperature, for example an equation or a map, which correlates the current value of the engine load parameter(s), in this case each couple of current values ES, ET of engine speed and engine torque, to a corresponding threshold value T_th of the exhaust gas temperature at the DPF inlet.

As a consequence, the threshold value T_th varies dynamically in response of each possible variation of the current value of the engine load parameter(s).

Each threshold value T_th represents the exhaust gas temperature value above which the temperature increase of the DPF 285, working under the corresponding value of the engine load parameter(s), could become excessive and damage the DPF 285 itself and/or other engine components.

Since it may happen that the engine load parameters vary faster than the thermodynamic behavior of the DPF 285, the routine provides that the current value(s) of the engine load parameter(s) monitored in the block 11, in this case both the current value ES of the engine speed and the current value ET of the engine torque, are adequately filtered (block 13) before being applied to the calculation module 12, for example by means of a respective low-pass filter. In this way, it is advantageously possible to prevent wrong diagnosis due to a too fast variation of the threshold value T_th.

The equation or map involved in the calculation module 12 can be empirically calibrated by means of an experimental activity, and stored in the memory system 460.

However, since the exhaust gas temperature at the DPF inlet generally decreases much more slowly than the engine load parameters, it could be difficult to calibrate the above mentioned equation or map in such a way that it can provide reliable threshold values T_th in that case.

For this reason, the present example provides for completing the diagnosis only if the exhaust gas temperature at the DPF inlet is actually increasing.

Accordingly, the routine provides for the ECU 450 to use the current value T of the exhaust gas temperature for calculating (block 14) the current value G of the variation over the time t (gradient) of the exhaust gas temperature at the DPF inlet, for example according to the following equation:

$$G = \frac{d T}{d t} .$$

Before being applied to the block 14, the routine provides that the current value T of the exhaust gas temperature is adequately filtered (block 15), for example by means of a low-pass filter, in order to improve the robustness of the calculation of the gradient value G.

The routine then provides for the ECU 450 to test (block 16) whether the current gradient value G is more than zero (exhaust gas temperature increasing) or not (exhaust gas temperature constant or decreasing).

If this test returns negative, the routine is not completed and simply restarted from the beginning.

If conversely the test returns positive, the routine provides for the ECU 450 to compare (block 17) the current value T of the exhaust gas temperature with the threshold value T_th that has been provided by the calculation module 12.

If the current value T is equal or below the threshold value T_th, it means that the thermal behavior of the internal combustion engine system 100 is normal, and the routine is repeated from the beginning.

If conversely the current value T is above the threshold value T_th, the routine provides the ECU 450 to diagnose that the DPF 285 is overheated (block 18).

Once a DPF overheating has been diagnosed, the ECU 450 may activate a recovery strategy (block 19). The recovery strategy can generally comprise any action suitable to stop the increase of the DPF temperature, in order to prevent damages of the DPF 285 itself as well as of other engine components. By way of example, the recovery strategy may provide for operating the ICE 110 according to a fuel injection pattern that reduces the amount of fuel injected in the cylinders 125. The recovery strategy may also provide for reducing the amount of air induced into the engine cylinders 125, for example by properly regulating the position of the throttle body 330.

While at least one exemplary embodiment has been presented in the foregoing summary and detailed description, it should be appreciated that a vast number of variations exist. It should also be appreciated that the exemplary embodiment or exemplary embodiments are only examples, and are not intended to limit the scope, applicability, or configuration in any way. Rather, the forgoing summary and detailed description will provide those skilled in the art with a convenient road map for implementing at least one exemplary embodiment, it being understood that various changes may be made in the function and arrangement of elements described in an exemplary embodiment without departing from the scope as set forth in the appended claims and in their legal equivalents.

What is claimed is:

1. A method for operating an internal combustion engine, comprising:
monitoring a value of a temperature parameter of a diesel particulate filter of the internal combustion engine;
monitoring a value of an operating parameter of the internal combustion engine indicative of an engine load;
using the monitored value of the engine load parameter to determine a threshold value of the diesel particulate filter temperature parameter;
testing whether the monitored value of the diesel particulate filter temperature parameter exceeds the determined threshold value thereof; and
diagnosing that the diesel particulate filter is overheated if the test returns positive.

2. The method according to claim 1, wherein the monitored value of the diesel particulate filter temperature parameter is measured by means of a sensor.

3. The method according to claim 1, wherein the engine load parameter is chosen among engine torque and engine speed.

4. The method according to claim 1, wherein the monitored value of the engine load parameter is filtered before being used to determine the threshold value of the diesel particulate filter temperature parameter.

5. The method according to claim 1, wherein the threshold value of the diesel particulate filter temperature parameter is determined by means of an empirically calibrated model or map that receives as input the monitored value of the engine load parameter and returns as output the threshold value.

6. The method according to claim 1, further comprising:
using the monitored value of the diesel particulate filter temperature parameter to calculate a value of a gradient of the diesel particulate filter temperature parameter; and
performing the test only if the calculated value of the gradient of the diesel particulate filter temperature parameter is positive.

7. The method according to claim 6, wherein the monitored value of the diesel particulate filter temperature parameter is filtered before being used to calculate the gradient value of the diesel particulate filter temperature parameter.

8. The method according to claim 1, further comprising:
activating a recovery strategy suitable to stop the increase of the diesel particulate filter temperature, if the overheating of the diesel particulate filter is diagnosed.

9. The method according to claim 8, wherein the recovery strategy further comprises one or more of the following:
reducing a quantity of fuel supplied into the internal combustion engine; and
reducing a quantity of air supplied into the internal combustion engine.

10. A computer program product for processing a signal, comprising:
a tangible storage means readable by a processing unit and storing instructions for execution by the processing unit for performing a method comprising:
monitoring a value of a temperature parameter of a diesel particulate filter of the internal combustion engine;
monitoring a value of an operating parameter of the internal combustion engine indicative of an engine load;
using the monitored value (ES, ET) of the engine load parameter to determine a threshold value of the diesel particulate filter temperature parameter;
testing whether the monitored value of the diesel particulate filter temperature parameter exceeds the determined threshold value thereof; and
diagnosing that the diesel particulate filter is overheated if the test returns positive.

11. An internal combustion engine, comprising:
a diesel particulate filter;
an engine control unit having a non-transitory memory system associated to the engine control unit, and a computer program product stored thereon, the computer program product configured to:
monitor a value of a temperature parameter of a diesel particulate filter of the internal combustion engine;
monitor a value of an operating parameter of the internal combustion engine indicative of an engine load;
use the monitored value (ES, ET) of the engine load parameter to determine a threshold value of the diesel particulate filter temperature parameter;
test whether the monitored value of the diesel particulate filter temperature parameter exceeds the determined threshold value thereof; and
diagnose that the diesel particulate filter is overheated if the test returns positive.

12. An apparatus for operating an internal combustion engine equipped with a diesel particulate filter, comprising:
means for monitoring a value of a temperature parameter of the diesel particulate filter;
means for monitoring a value of an operating parameter of the internal combustion engine indicative of an engine load;
means for using the monitored value of the engine load parameter to determine a threshold value of the diesel particulate filter temperature parameter;
means for testing whether the monitored value of the diesel particulate filter temperature parameter exceeds the determined threshold value thereof; and
means for diagnosing that the diesel particulate filter is overheated if the test returns positive.

13. An automotive system comprising:
an internal combustion engine equipped with a diesel particulate filter;
a first sensor for evaluating a temperature parameter of the diesel particulate filter;
a second sensor for evaluating an operating parameter of the internal combustion engine indicative of an engine load; and
an electronic control unit in communication with the first and the second sensor, wherein the electronic control unit is configured to:
monitor with the first sensor a value of the diesel particulate filter temperature parameter;
monitor with the second sensor a value of the engine load parameter;
use the monitored value of the engine load parameter to determine a threshold value of the diesel particulate filter temperature parameter;
test whether the monitored value of the diesel particulate filter temperature parameter exceeds the determined threshold value thereof; and
diagnose that the diesel particulate filter is overheated if the test returns positive.
